(19) United States
(12) Patent Application Publication
(10) Pub. No.: US 2010/0333154 A1
(43) Pub. Date: Dec. 30, 2010

(54) SYSTEMS AND METHODS FOR PROVIDING A MASHUP IN A CONTENT PROVIDER ENVIRONMENT

(75) Inventors: Charles Dasher, Lawrenceville, GA (US); Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television, Inc.

(21) Appl. No.: 12/494,856

(22) Filed: Jun. 30, 2009

(51) Int. Cl. H04N 7/173

(52) U.S. Cl. 725/98

(57) ABSTRACT

Various embodiments of the present invention provide systems and methods for providing a mashup in a content provider environment. In particular embodiments, the systems and methods provide a mashup that is customized based on a subscriber's preferences on what content to include in the mashup and on what format the content is presented. Furthermore, in various embodiments, the mashup is provided to the subscriber through a content provider's environment such as a video on demand (VOD) service.

### BACKGROUND OF THE INVENTION

1. Field of the Invention

The disclosed invention generally relates to systems and methods for providing a mashup in a content provider environment, and more specifically, to systems and methods for providing a mashup that is customized based on a subscriber's preferences and that is provided to the subscriber through a content provider's environment such as a video on demand service.

2. Description of the Related Art

Today, many cable service and satellite TV providers offer a wide range of products and services to their subscribers. For instance, one such service is video on demand (VOD) programming or audio video on demand (AVOD) that allow subscribers to select and watch/listen to video and/or audio content on demand. In addition, providers of Web content offer a wide range of products and service to Internet users. However, in many instances, an individual is required to access these products and services via separate mechanisms. That is, an individual is required to access a cable service provider's products and services through the cable provider's system using a set-top box and the individual is required to access a Web content provider's products and services over the Internet through the individual's computer.

Social networks are becoming increasingly popular. One such social networking tool is a mashup. A mashup is an application that combines data or functionality from two or more sources into a single integrated application. Typically, a mashup is provided via a Web application and a user of the mashup will access the mashup through a Web page. However, it is desirable to be able to access such a tool through a cable service provider's and satellite TV provider's system. This would allow a subscriber to access Web content of interest to the subscriber without the subscriber having to leave the cable service provider's or satellite TV provider's system to do so. Such as, for instance, allowing a subscriber to access Web content by using a service provider's VOD service.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for fulfilling mashup content requests according to various embodiments of the invention.

FIG. 2 is a schematic diagram illustrating a cable service provider's system according to various embodiments of the invention.

FIG. 3 is a schematic diagram illustrating a mashup server residing in the system shown in FIG. 2 according to various embodiments of the invention.

FIG. 4 is a schematic diagram illustrating a set-top box residing in the system shown in FIG. 2 according to various embodiments of the invention.

FIG. 5 is a flow diagram of a configuration tool module according to various embodiments of the invention.

FIGS. 6A-6B is flow diagrams of a mashup module according to various embodiments of the invention.

FIG. 7 is a flow diagram of a set-top box module according to various embodiments of the invention.

FIG. 8 is an example of a subscriber's mashup screen according to various embodiments of the invention.

FIG. 9 is an example of additional content for a content item on a subscriber's mashup according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### Brief Overview of an Embodiment

Various embodiments of the present invention provide systems and methods for providing a mashup in a content provider environment, such as a cable service provider and/or satellite TV provider. The term “mashup” is used from this point forward to comprise a display of two or more user-defined content items in one or more user-defined formats. A “content item” is a type of content associated with a particular data source. For instance, a content item may be the local news headlines found on a particular website. A “data source” is the source used to retrieve content for the content item. For instance, a data source may be a Web page and/or a document embedded in a Web page or stored in local or remote memory. Furthermore, the term “provider” is used from this point forward to indicate a cable service provider or a satellite TV provider or any other provider of distributed media content.

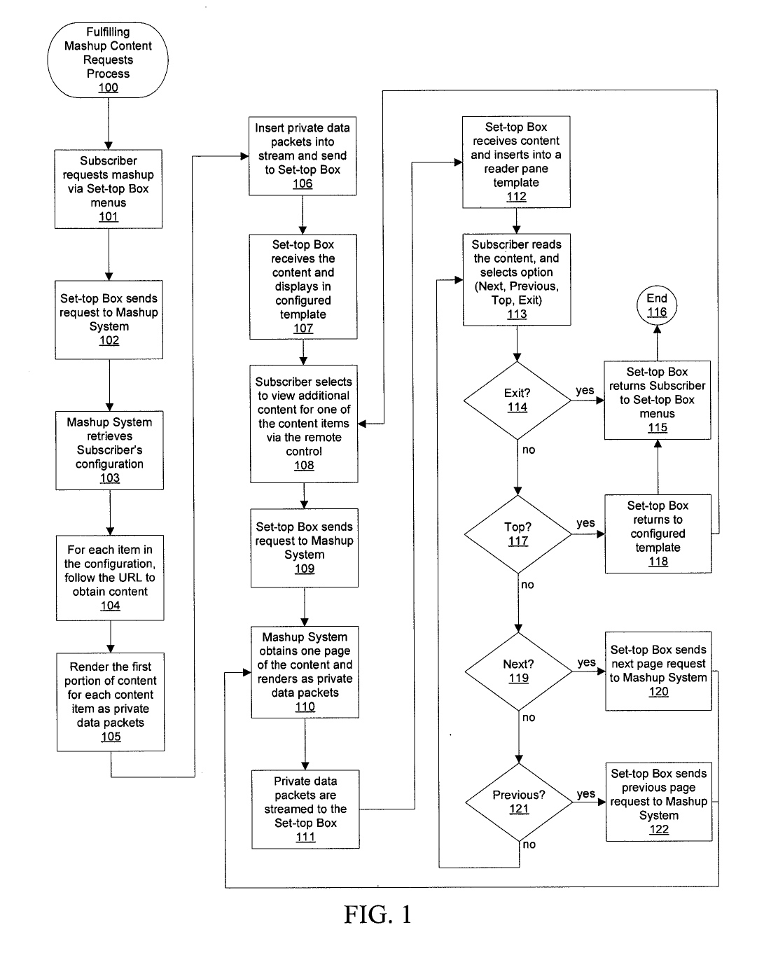

FIG. 1 illustrates one embodiment of a flow diagram of a process 100 for fulfilling mashup content requests over a provider's system. The subscriber may be watching a particular program on the subscriber's set-top box and decides that he or she would like to view his or her mashup. Thus, the process begins at Step 101 with the subscriber requesting his or her mashup by using one or more menus on the subscriber's set-top box. For instance, in one embodiment, the subscriber selects the provider's VOD service, maneuvers through one or more screens, and selects a button on the subscriber's remote control signaling the set-top box to bring up the subscriber's mashup.

As is described in greater detail below, in various embodiments, the subscriber first configures a mashup and specifies what content items to include in the subscriber's mashup. For instance, the subscriber may select from one or more mashup templates and may indicate what content items to include and in what format on the template. For example, the subscriber may indicate to include major league baseball scores on the top right corner of the mashup, the local news headlines on the top left corner of the mashup, and one or more individuals from the subscriber's facebook® on the bottom half of the mashup. Further, the subscriber may indicate what source to use to obtain the content for each entry (e.g., content item) on the mashup. For instance, in one embodiment, the subscriber may enter or select a uniform resource locator (URL) that is used to locate the particular content item. While in another embodiment, the URL may be tied to a particular content item and the source for the content item is automatically identified when the subscriber selects the particular content item. Thus, once the subscriber has finished selecting the different content items to include on the subscriber's mashup, the subscriber's configuration is saved and used to construct the subscriber's mashup whenever requested by the subscriber. This configuration may be saved in some sort of storage medium at a central location in the provider's system (e.g., remote from the subscriber's set-top box) or may be saved locally on the subscriber's set-top box. Further, in various embodiments, the content items on a subscriber's mashup may not all be subscriber defined. For instance, in various embodiments, the cable provider may include content items on the subscriber's mashup such as advertising.

Returning to the process 100, in Step 102, the set-top box receives the command and sends the request to the provider's mashup system. In various embodiments, the provider's mashup system is centrally located and may service one or more headends of the provider. Thus, the set-top box sends the request over the provider's distribution network to the headend and the headend directs the request to the mashup system.

In various embodiments, the mashup system determines which subscriber has made the request and retrieves the subscriber's configuration (e.g., the subscriber's mashup configuration data), shown as Step 103. In other embodiments, the subscriber's configuration may be stored locally on the subscriber's set-top box and the request may include information on the content items that are included in the subscriber's mashup.

In various embodiments, the system reads the configuration or request and for each content item, the system obtains the content for the item by utilizing the URL associated with the item, shown as Step 104. For example, the user may have selected a content item comprising major league baseball scores. This particular item may indicate the URL for the scoreboard located on major league baseball's official website. Thus, in one embodiment, the mashup system is in communication with the Internet and obtains the scores over the Internet by visiting the website associated with the URL. In another embodiment, the mashup system may periodically poll the website for content and store the content locally. Thus, in this particular embodiment, the mashup system obtains the content for the particular item from the locally stored content without having to access the website over the Internet. In particular instances, this may be more helpful than accessing the Internet each time for content that is popular with many subscribers because the system may be able to retrieve the content more quickly. Therefore, in various embodiments, the mashup system may obtain content both from the Internet and locally.

In addition, in various embodiments, the mashup system may subscribe to RSS/Atom newsfeeds or other content update announcement schemes. Thus, in these particular embodiments, when the content source is updated, the mashup system is notified and the system immediately pulls the content into local memory. Therefore, if multiple subscribers have requested the content, the system can use a single copy for all of the subscribers. Furthermore, in various embodiments, the system can alert a subscriber once a notification is received via a ticker optionally displayed along with the programming the subscriber is currently watching. Other sources of content may include content created by subscribers and stored on a web site and/or in a VOD system, and/or content from a cell phone service or Twitter® (such as text messages). Such content sources are detailed in U.S. patent application Ser. No. 12/347,430 filed on Dec. 31, 2008 and entitled “Systems, Methods, and Apparatus for Tagging Segments of Media Content,” and U.S. patent application Ser. No. 12/494,425 file on Jun. 30, 2009 and entitled “Systems and Methods for Incorporating User Generated Content Within a VOD Environment,” which are both incorporated herein by reference in their entirety.

Returning to the process 100, in Step 105, the mashup system renders a first portion (e.g., a subset of content) of each content item as one or more data packets. In various embodiments, these first portions are the content initially shown for each content item on the mashup. In addition, in various embodiments, these data packets are constructed solely to be sent to the subscriber's set-top box to provide the mashup for the subscriber. Further, the mashup system generates the data packets in an encoding format compatible with the provider's system. For instance, in one embodiment, the mashup system calls a transcoder or transcoding system to transcode the portions of content items into a format compatible with the provider's VOD system. For example, such formats include CableLabs® MPEG2 Transport SD, CableLabs® MPEG2 Transport HD, H.264 Transport SD with MPEG audio or AAC audio, H.264 Transport HD with AAC audio, and/or H.264 web format with AAC audio.

In Step 106, the mashup system inserts the one or more data packets into a stream and sends the packets to the subscriber's set-top box. Thus, in various embodiments, the mashup system streams the data packets through the provider's headend, over the provider's distribution network, to the subscriber's set-top box. In many instances, since the data packets are generated for a particular subscriber, the headend directs the data packets over a unicast stream to the subscriber's set-top box. Thus, in various embodiments, the headend may transmit data to the subscriber's set-top box identifying a stream comprising the one or more data packets and may transmit the one or more data packets over the stream to the subscriber's set-top box. In turn, the set-top box tunes to the channel carrying the stream as identified in the data. In other embodiments, the headend may combine the one or more data packets along with the current programming to be streamed to the subscriber's set-top box into a combined stream. Thus, in various embodiments, the combined stream is a distinct stream that comprises the stream that includes the one or more data packets and the stream that includes the current programming. Therefore, in Step 107, the set-top box receives the data packets and displays the portion of the content for each content item as configured on the template. In particular embodiments that utilize the combined stream, the portion of the content for each content item may visually appear to be superimposed over the current programming on the subscriber's television screen.

In various embodiments, the data packets may be provided like any other type of content that is streamed to the set-top box and the set-top box simply displays the packets as received. For instance, the mashup system may utilize a system to construct one or more MPEGs, such as I-frames, to represent the mashup and may stream the MPEGs to the subscriber's set-top box. Such a system is detailed in U.S. patent application Ser. No. 12/406,493 filed on Mar. 18, 2009 and entitled “Systems and Methods for Providing a Dynamic User Interface for a Settop Box,” which is incorporated herein by reference in its entirety.

In other embodiments, the mashup system may simply include the portion of content for each content item in the data packets and the set-top box constructs the subscriber's mashup. In these particular embodiments, an application, such as a VOD application providing VOD service, residing on the set-top box may be modified to receive the data packets and to construct the packets into the mashup based on the configuration locally stored on the set-top box. In other embodiments, a stand-alone application may reside on the set-top box that receives the data packets and constructs the packets into the mashup.

Continuing with the process 100, the subscriber's mashup is displayed on the subscriber's television. The subscriber may read the portions of content for each content item on the mashup and may wish to read further content associated with one of the items displayed on the mashup. For instance, the subscriber may want to read the box score for a particular baseball score displayed on the mashup. The subscriber indicates a selection of additional content for one of the items to the set-top box. For instance, the subscriber indicates the selection of the additional content on the mashup by pressing one or more buttons on the subscriber's remote control, shown as Step 108.

In Step 109, the set-top box sends a request to the mashup system over the provider's distribution system for additional content pertaining to the content item. The mashup system receives the request, obtains the additional content (e.g., an amount of content that can be displayed on the subscriber's television screen), and renders the content as one or more data packets, shown as Step 110. For instance, the mashup system obtains the additional content from the website indicated in the configuration or from local memory. Thus, in the example, the mashup system obtains the first page of the box score for the baseball score selected by the subscriber and renders the first page in a format compatible with the subscriber's system.

The mashup system then streams the data packets over the provider's cable distribution system to the subscriber's set-top box, shown as Step 111. The set-top box receives the packets and generates a signal from the packets to display to the subscriber. For instance, in one embodiment, the set-top box may insert the content into a reader pane template, shown as Step 112. While in another embodiment, the mashup system may construct the page of content and send the constructed page in the data packets. Thus, the subscriber is able to read the first page of the box score for the particular baseball score.

The subscriber reads the first page of the box score and can select one or more options, shown as Step 113. For instance, in one embodiment, the subscriber is provided with the options to select from such as: (1) “exit” to exit the page and mashup and return to the menu; (2) “top” to return to the initial page of the mashup; (3) “next” to move to the next page of content; and (4) “previous” to move to the previous page of content. Therefore, the subscriber selects one of the options by pressing one or more buttons on the subscriber's remote control and the set-top box receives the selection. In response, the set-top box determines whether the user has selected the “exit” option, shown as Step 114. If the subscriber has selected the “exit” option, the set-top box returns the subscriber to the menus the subscriber used to request the mashup, shown as Step 115. At this point the process 100 ends, shown as Step 116.

If the subscriber has not selected the “exit” option, the set-top box determines whether the subscriber has selected the “top” option, shown as Step 117. If so, the set-top box returns to the configured template and displays the initial page of the subscriber's mashup, shown as Step 118. At this point, the user may select additional content to view for another content item (shown as Step 108) or may exit the mashup to the set-top menus (shown as Step 115).

If the subscriber has not selected the “top” option, the set-top box determines whether the subscriber has selected the “next” option, shown as Step 119. If the subscriber has selected this option, the set-top box sends a next page request to the mashup system, shown as Step 120. Thus, the mashup system obtains the next page of the content, renders the content as one or more data packets, and streams the packets to the subscriber's set-top box, shown as Steps 110 and 111. The process 100 continues until the subscriber exits the mashup and returns to the set-top box menus, shown as Step 115.

Finally, if the subscriber has not selected the “next” option, the set-top box determines whether the subscriber has selected the “previous” option, shown as Step 121. If the subscriber has selected the “previous” option, the set-top box sends a previous page request to the mashup system, shown as Step 122. Similar to receiving a next page request, in response, the mashup system obtains the previous page of content for the item, renders one or more data packets, and streams the packets to the subscriber's set-top box, shown as Steps 110 and 111. The process 100 finally ends upon the subscriber indicating to the set-top box to return to the menus (shown as Steps 115 and 116).

As a result, the subscriber is provided with a mashup through the provider's system that is made up of content items of particular interest to the subscriber. Furthermore, the subscriber is able to select items on his or her mashup and is able to receiver further content for the selected items.

### System Architecture

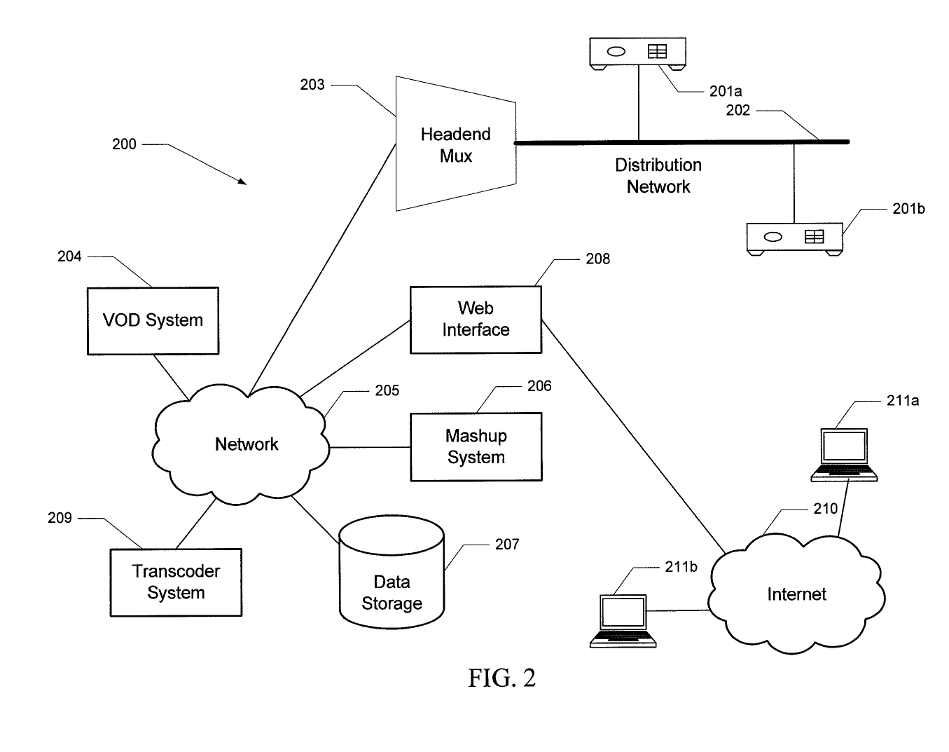

A media content providing system 200 according to various embodiments of the invention is shown in FIG. 2. For instance, the system 200 may be a cable provider's system 200 providing cable programming to the cable provider's subscribers. However, the system 200 may also be a satellite TV provider's system. Therefore, the system 200 depicted in FIG. 2 is provided for illustrative purposes only and should not be construed to limit the scope of the claimed invention.

As may be understood from this figure, in various embodiments, the system 200 includes one or more set-top boxes 201a, 201b. In general, these set-top boxes 201a, 201b are devices that are used by subscribers to receive digital cable signals for television and are configured to send data to the headend 203 of the system 200. For example, one of the set-top boxes 201a, 201b may be a device, such as a personal video recorder (PVR) provided by a cable company. The PVR receives the digital cable signal and feeds the signal into an individual's television set so that the individual can view the cable company's cable television programming.

As shown, in various embodiments, the set-top boxes 201a, 201b communicate with the headend 203 of the system 200 over a distribution network 202. The headend 203 routes messages (e.g., subscriber inputs) received from the set-top boxes 201a, 201b to various components of the provider's system 200 and streams content (e.g., selected VOD programs) to the set-top boxes 201a, 201b. For instance, in one embodiment, the headend 203 receives input from the user via one of the set-top boxes 201a, 201b, interprets the input, and sends the input to the appropriate component of the system 200, such as the VOD system 204 or the mashup system 206.

In addition, the system 200 of various embodiments may also include a transcoder system 209. This system 209 is configured to perform specific functions within the system 200. For instance, described in further detail below, the transcoder system 209 may include software and/or hardware components configured to transcode various content into a format that is compatible the provider's distribution network 202 and corresponding set-top boxes 201a, 201b. Furthermore, several of the components of the system 200 are connected via a network 205 within the system 200 (e.g., a LAN, a wireless network, and/or a private network) and communicate with one another.

As depicted in FIG. 2, the system 200 may also include storage medium, such as data storage 207. The data storage 207 is also connected via the network 205 and communicates with other components of the system 200. In various embodiments, the data storage 207 may store subscribers' configurations for their mashups and/or the content for the mashups.

Furthermore, in various embodiments, the system 200 may include a Web interface 208 that is communication with the other components of the system 200. The Web interface 208 may also be in communication with the Internet 210 and may support one or more websites. Various users may access these websites from their personal computers 211a, 211b over the Internet 210. For example, a user may access the websites from a cable modem.

In various embodiments, the components of the system 200 may be one or more devices or may include one or more devices executing software programs. Furthermore, in various embodiments, the storage medium 207 may be one or more types of medium such as hard disks, magnetic tapes, or flash memory.

### Exemplary Mashup System

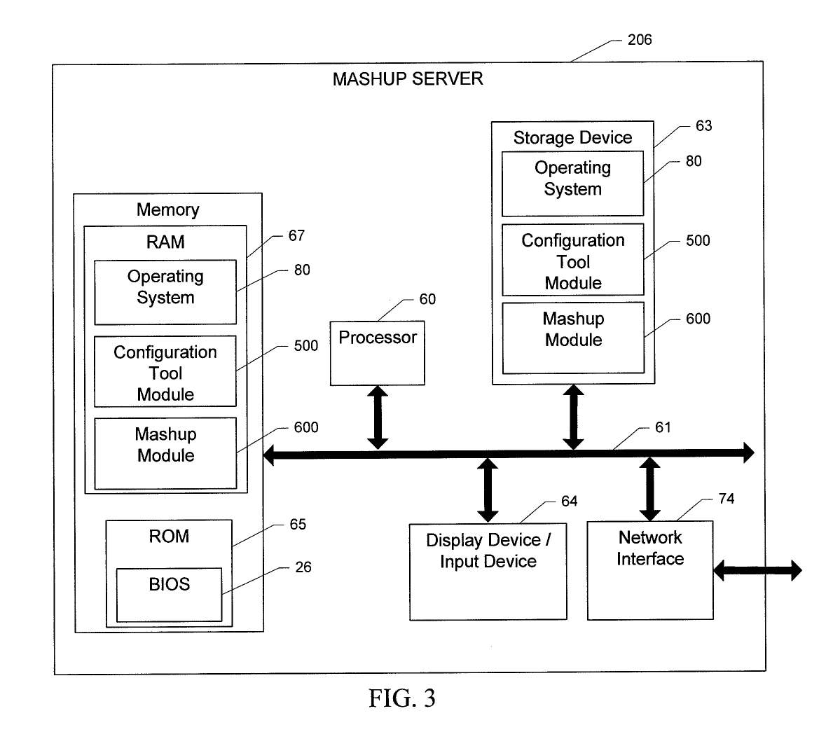

FIG. 3 shows a schematic diagram of the mashup system 206 shown in the system 200 depicted in FIG. 2 according to one embodiment of the invention. In this particular embodiment, the mashup system 206 is provided as a server. However, it should be understood that the mashup system 206 does not necessarily need to be a single server. For instance, in various embodiments, the mashup system 206 may be provided via one or more servers executing one or more software applications. Thus, the server 206 shown in FIG. 3 is provided for illustrative purposes only and should not be construed to limit the scope of the invention.

In FIG. 3, the server 206 includes a processor 60 that communicates with other elements within the server 206 via a system interface or bus 61. Also included in the server 206 is a display device/input device 64 for receiving and displaying data that may be used by administrative personnel. This display device/input device 64 may be, for example, a keyboard or pointing device that is used in combination with a monitor. The server 206 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 206. Alternatively, the server 206 can operate on one computer or on multiple computers that are networked together.

In addition, the server 206 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 206. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 3, program modules of the mashup server 206 may include an operating system 80, a configuration tool module 500, and a mashup module 600. These modules 500, 600 may be used to control certain aspects of the operation of the server 206, as is described in more detail below, with the assistance of the processor 60 and an operating system 80.

Also located within the server 206 is a network interface 74, for interfacing and communicating with other elements of one or more networks (such as the network 205 described in the media content providing system 200 depicted in FIG. 2.) It will be appreciated by one of ordinary skill in the art that one or more of the server's 206 components may be located geographically remotely from other server 206 components. Furthermore, one or more of the components may be combined, and additional components performing functions described herein may be included in the system 200.

### Exemplary Set-Top Box

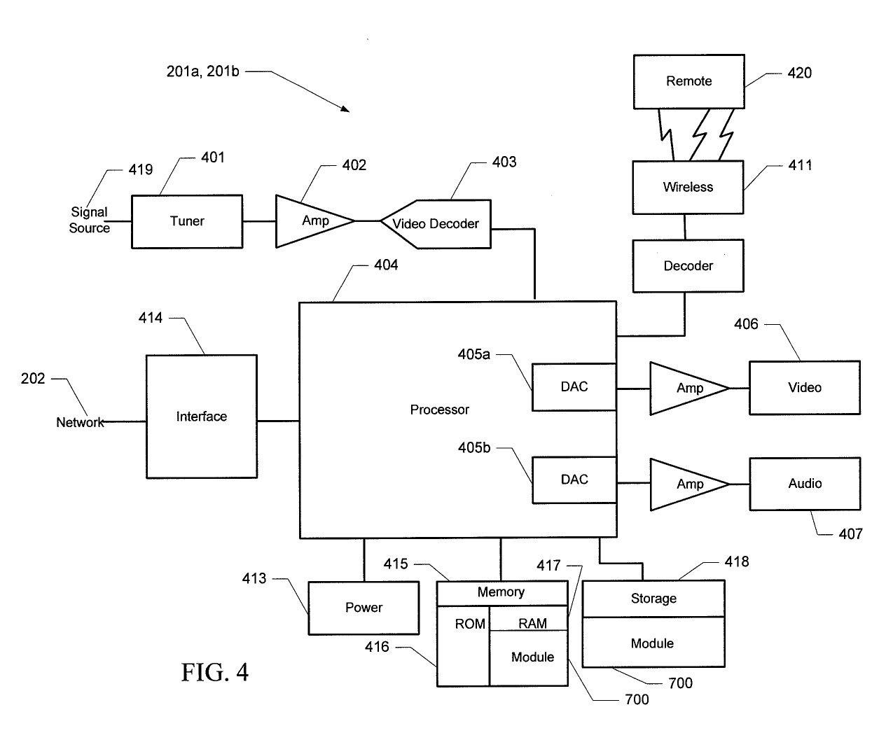

FIG. 4 shows a schematic diagram of a set-top box 201a, 201b according to one embodiment of the invention. The particular set-top box 201a, 201b depicted in FIG. 4 is configured to receive a digital signal from a cable provider or a satellite TV provider and to convert the signal into audiovisual content that is typically displayed on a television.

The particular embodiment of the set-top box 201a, 201b shown in FIG. 4 includes a processor 404 and storage 418, such as a hard disk drive and/or a flash drive, on which audiovisual data may be recorded and stored by the processor 404. In addition, the set-top box 201a, 201b further includes memory 415 composed of both read only memory (ROM) 416 and random access memory (RAM) 417.

The set-top box 201a, 201b further includes a tuner 401 configured to receive the incoming source signal 419. The tuner 401 sends the source signal 419 through an amplifier 402 and a video decoder 403 configured to translate the encoded source signal 419 into its original format. The video decoder 403 directs the translated source signal 419 to the processor 404.

In various embodiments, the processor 404 may also include a digital-to-analog converter (DAC) 405a, 405b configured to convert the translated source signal 419 from a digital signal to an analog signal if the television will only read an analog signal. Furthermore, the processor 404 is configured to feed the translated signal to the video and audio outputs 406, 407 of the set-top box 201a, 201b that are connected to the television.

In addition, the set-top box 201a, 201b may also include a wireless interface 411 that is configured to receive commands (and/or input) from a viewer via transmission from a remote control 420. The remote control 420 may transmit such commands using any number of transmitters, such as a radio frequency transmitter, a supersonic transmitter, or an optical transmitter. Further, the remote control 420 may be configured with cell-phone-spelling style features so that a subscriber may enter text.

A number of program modules (such as module 700) may also be stored within the storage 418 and/or within the RAM 217 of the set-top box 201a, 201b. This module 700 may be used to control certain aspects of the operation of the set-top box 201a, 201b, as is described in more detail below, with the assistance of the processor 404.

Also located within the set-top box 201a, 201b is an interface 414, for interfacing and communicating with other elements of a network (such as the headend 203 in communication with the distribution network 202 described in the system 200 depicted in FIG. 2.) It will be appreciated by one of ordinary skill in the art that one or more of the set-top box's 201a, 201b components may be located geographically remotely from other set-top box 201a, 201b components. Furthermore, one or more of the components may be combined, and additional components performing functions described herein may also be included in the set-top box 201a, 201b.

### Exemplary System Operation

In various embodiments, system operation can be considered as two phases. In various embodiments, the first phase of system operation (e.g., configuration phase) involves utilizing a configuration tool module 500 so that a subscriber can configure his or her mashup. This configuration tool module 500 may reside on the mashup system 206 (e.g., server) and/or the subscriber's set-top box 201a, 201b. The second phase of system operation involves providing the subscriber with his or her mashup for viewing (e.g., viewing phase). For instance, in various embodiments, the mashup system 206 also includes a mashup module 600 that is adapted to provide the subscriber with the subscriber's mashup and to provide additional content for items selected by the subscriber on the subscriber's mashup. Furthermore, in various embodiments, the set-top box 201a, 201b may include a module 700. In these particular embodiments, this module 700 is adapted to perform one or more tasks such as construct a subscriber's mashup from a configuration, generate signals to display a subscriber's personal mashup (and associated content) on the subscriber's television, to allow the subscriber to select to view additional content for a particular content item on the mashup, and to generate signals to display further content for the selected item on the subscriber's television for viewing. These modules 500, 600, 700 are described in more detail below.

### Configuration Tool Module

As previously discussed, in various embodiments, the mashup system 206 and/or subscriber's set-top box 201a, 201b may include a configuration tool module 500 that is adapted to provide the tools necessary to allow a subscriber to configure the subscriber's mashup. The subscriber may access these tools (e.g., the module 500) in various ways according to embodiments. For instance, in one embodiment, the subscriber accesses the module 500 through the subscriber's set-top box 201a, 201b. Thus, for example, the subscriber may call up an application on the subscriber's television that resides in the VOD service on the subscriber's set-top box 201a, 201b or that resides in a stand-along service. In another embodiment, the subscriber may access the configuration tool module 500 through one or more Web pages. For example, the mashup system 206 may be in communication with a Web interface 208 that provides a website on the Internet 210 (as shown in the system 200 depicted in FIG. 2). Thus, the subscriber visits the website over the Internet 210 and configures the subscriber's mashup by accessing the configuration tool module 500 through the website.

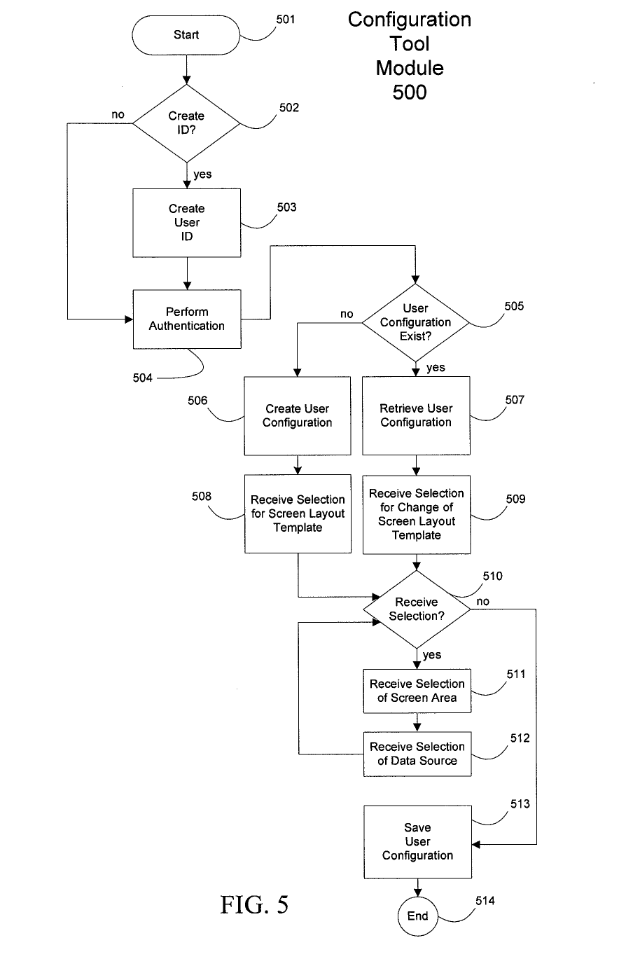

Accordingly, FIG. 5 illustrates a flow diagram of a configuration tool module 500 according to various embodiments. This flow diagram may correspond to the steps carried out by the processor 60 in the mashup server 206 shown in FIG. 3 or the processor 404 in the set-top box 201a, 201bs shown in FIG. 4 as it executes the module 500 in the server's or set-top box's RAM memory 67, 417 according to various embodiments.

Therefore, the subscriber enters into the configuration tool and the configuration tool module 500 determines whether to create a user identifier for the subscriber, shown as Step 502. In various embodiments, the subscriber may be provided with an initial login screen. For instance, in one embodiment, the screen requests the subscriber's username and password or provides an option for the subscriber to create a username and password. Therefore, the subscriber may select the option to create a username and password and enters a username and password (along with other relevant information) on a subsequent screen. In response, the configuration tool module 500 verifies the username and password are valid (e.g., verifies that the username and/or password are unique) and creates the user identifier. In other embodiments, such as for example, when the configuration tool module 500 resides on the subscriber's set-top box 201a, 201b and the configuration is stored locally on the set-top box 201a, 201b, the subscriber may simply indicate on the initial screen to create a user identifier.

In various embodiments, the user identifier uniquely identifies the particular subscriber and can be used to retrieve the subscriber's configuration and allow the subscriber to manage his or her configuration. Once the module 500 has created the identifier, the module 500 may save the identifier in some storage medium, such as the data storage 207 shown in the system 200 depicted in FIG. 2 or storage on the set-top box 201a, 201b.

If the configuration tool module 500 determines that a user identifier does not need to be created, in various embodiments, the module 500 may perform an authentication process for the particular subscriber, shown as Step 504. For instance, in one embodiment, the module 500 may read the subscriber's username and password and confirms the username and password match (that is, the module 500 may confirm the subscriber has entered the correct password for the entered username).

Once the configuration tool module 500 authenticates the subscriber's username and password, the module 500 determines whether a configuration (e.g., configuration data) exists for the subscriber, shown as Step 505. For instance, in one embodiment, the configuration is stored in a database or in one or more files on storage medium in the provider's system or stored in one or more files locally on the set-top box 201b, 201b. In the embodiments in which configurations are stored in the provider's system, the configuration tool module 500 queries the storage medium (using the subscriber's unique identifier, for example) to determine whether a configuration exists for the particular subscriber. If the module 500 determines a configuration does exist for the subscriber, the module 500 retrieves the configuration, shown as Step 507. If the module 500 determines a configuration does not exist for the subscriber, the module 500 creates a configuration for the subscriber, shown as Step 506.

In various embodiments, if the module 500 creates a configuration for the subscriber, the configuration tool module 500 provides the subscriber with a first screen that requests that the subscriber select a layout template for his or her mashup. Thus, the module 500 may provide the subscriber with a listing of screen layout templates to choose from. The subscriber scrolls through the listing and reviews the different layouts that are available. The subscriber selects a particular layout and the configuration tool module 500 receives the subscriber's selection, shown as Step 508.

In various embodiments in which the module 500 retrieves the subscriber's configuration, the module 500 may provide the subscriber with the option to change the screen layout template. Thus, the configuration tool module 500 provides a screen so that the subscriber may select a new screen layout template and receives the subscriber's change of template as input if the subscriber does select a new template, shown as Step 509.

These layout templates may vary among embodiments. For instance, several of the templates may provide a layout of a screen that has several partitioned areas (with different configurations) that can be used to display different content. Another embodiment may include a “ticker” template that provides a ticker that runs across a subscriber's television screen and constantly streams content across the ticker and is superimposed on the current programming being shown on the subscriber's television. For instance, in some embodiments, the ticker runs along the top or bottom of the subscriber's television screen. In addition, in various embodiments, the ticker may provide headlines or provide new content headlines from the subscriber's mashup. In particular embodiments, the subscriber may be provided the option to jump to the subscriber's mashup directly from the ticker (or from the current programming) and to return to the current programming from the mashup. In addition, in various embodiments, the subscriber may be provided the option to jump to additional content for an item listed on the ticker and to return to the current programming after viewing the additional content. Further, in these particular embodiments, the subscriber's set-top box 201a, 201b may be configured to automatically start to record the current programming (e.g., PVR) when the subscriber jumps to the mashup or additional content so that when the subscriber returns to view the current programming, he or she can continue to watch the programming from the point at which he or she left the programming to view the mashup or additional content. Further, in various embodiments, the ticker may remain superimposed as the subscriber changes the channel on the television (e.g., changes the programming being viewed on the subscriber's television).

Furthermore, in various embodiments, these templates may include additional options that allow the subscriber to further format the content. For instance, one embodiment may include templates that allow a subscriber to identify textual content to be voice synthesized when provided on the subscriber's mashup. While another embodiment may include templates that allow a subscriber to identify a particular area of the mashup for displaying streaming video from a data source.

Thus, in Step 510, the configuration tool module 500 determines whether the subscriber has provided a selection of a particular content item to include in the subscriber's mashup. For instance, in one embodiment, the module 500 provides the subscriber with a “freeform” of the selected template and the subscriber enters information into the freeform to indicate what content items are to be provided in the mashup. For example, the freeform may allow the subscriber to define an area of the mashup for a particular content item and the subscriber may type in one or more URLs on the freeform area as data sources for the particular content item.

In other embodiments, the configuration tool module 500 provides a listing of content items and/or data sources for the subscriber to select from. In these particular embodiments, the subscriber selects from the listing to identify the content items and/or the data sources for the mashup. For example, the module 500 may provide a listing that includes such content items as: (1) major league baseball scores; (2) world news headlines; and (3) local weather. Further, the module 500 may provide one or more data sources for each content item. For instance, the module may provide the data sources: (1) the ESPN® website; (2) the CBS Sports® website; and (3) the official website of Major League Baseball® as data sources for the content item major league baseball scores. In further embodiments, the configuration tool module 500 may provide a listing of available content items and/or data sources and may also allow the subscriber to enter one or more content items and/or data sources. For instance, the subscriber may select major league baseball scores and corresponding website for ESPN® from a listing of content items and data sources and may enter by freeform one or more of the subscriber's friends from facebook® as additional data sources.

If the configuration tool module 500 determines that the subscriber has provided a selection of a content item, the module 500 receives the subscriber's selection, shown as Step 511. For instance, as previously described, the module 500 receives a selection of a data source for the content item, such as a URL. Further, in Step 512, the configuration tool module 500 receives a format for the content item. For instance, in various embodiments, the configuration tool module 500 receives a selection for one of the predefined screen areas of the selected template for the content item. Further, the subscriber may select one or more formats for the content item, such as font size of text, color of the text, and/or whether the text is to be voice synthesized. As a result, the subscriber's mashup includes the selected content item in the selected content format.

At this point, the configuration tool module 500 determines whether the subscriber has entered an additional selection of a content item and/or corresponding data source. If the module 500 determines that an additional selection has been made, the module 500 continues with the process already describe in which the module 500 receives the selection of content and receives the format of the content (that is, the module 500 repeats Step 511 and 512). This process continues until the configuration tool module 500 determines the subscriber has not entered any additional content items.

In response to the subscriber not entering any additional selections of content, the module 500 saves the subscriber's configuration for his or her mashup, shown as Step 513. The module 500 may save the configuration in one or more storage medium on the provider's system or may save the configuration on the subscriber's set-top box 201a, 210b.

For example, in one embodiment, the configuration tool module 500 may save the subscriber's configuration in a database along with the subscriber's unique identifier so that the configuration may be retrieved from the database. Yet, in another embodiment, the configuration tool module 500 may save the configuration in a file and store the file. In this particular embodiment, the module 500 may also store a record in the database that includes the storage location of the file along with the subscriber's unique identifier so that the file may be retrieved from storage upon request. One of ordinary skill in the art can envision several ways to store the configuration in light of this disclosure. Once the configuration has been stored, the configuration can be retrieved and used to construct the subscriber's mashup as is described in more detail below.

### Mashup Module

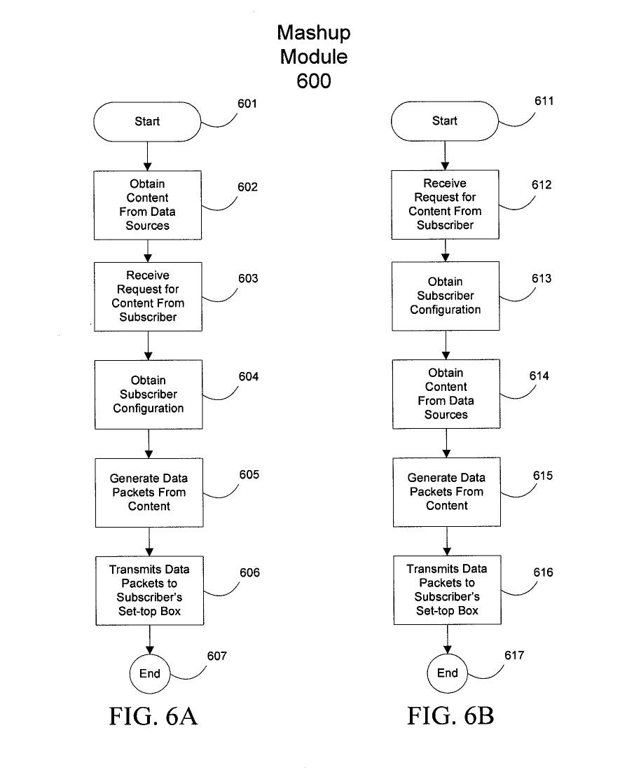

In various embodiments, the mashup system 206 may also include a mashup module 600 that is configured to provide a subscriber with the subscriber's mashup and/or associated content for items displayed on the mashup. In various embodiments, the mashup system 206 is located at a central location within the provider's system (for example, as shown in FIG. 2) and receives a request that is routed over the provider's cable distribution network 202 from the subscriber's set-top box 210a, 201b. Accordingly, FIGS. 6A and 6B illustrate flow diagrams of the mashup module 600 according to various embodiments. These flow diagrams may correspond to the steps carried out by the processor 60 in the mashup server 206 shown in FIG. 3 as it executes the module 600 in the server's RAM memory 67 according to various embodiments.

For instance, in various embodiments, the subscriber may request his or her personal mashup to stream through his or her set-top box 210a, 201b. The subscriber's request is sent over the provider's distribution network 202 to the provider's headend 203. In various embodiments, this request may include the subscriber's unique identifier or some other mechanism to identify the subscriber. In turn, the headend interprets the request and routes the request to the mashup system 206.

In various embodiments, the mashup module 600 may poll the information from the various data sources at different stages of providing the subscriber with his or her mashup and/or content for his or her mashup. For instance, in various embodiments, the mashup module 600 may obtain content from the data sources prior to receiving the subscriber's request. FIG. 6A displays the flow diagram for such a module 600 according these various embodiments.

Thus, in Step 602, the mashup module 600 obtains content from various data sources. In one particular embodiment, the mashup module 600 may be configured to poll the data sources at a predetermined interval of time and store the content locally in one or more storage medium. For instance, the mashup system 206 may store a listing of the various data sources that provide content to the mashups of the provider's subscribers.

In one embodiment, the listing may be stored in a database. The mashup module 600 queries the database to determine whether a particular data source needs to be polled. For instance, the database stores the date and time along with each data source that indicates the last time the data source was polled. If the mashup module 600 determines the predetermined time period has elapsed since the last time a particular data source has been polled, the mashup module 600 polls the particular data source to obtain content from the data source.

In another embodiment, the mashup module 600 may use information associated with the data source to determine whether the source should be re-polled. For instance, the mashup module 600 may be configured to analyze cache controls found in a HTTP header. For example, the “Expires” control found in various HTTP headers is a date and time that tells how long the associated representation (e.g., associated HTML pages, images, and files) of the Web page is fresh. Therefore, the mashup module 600 checks this control to determine whether the associated content has expired and needs to be re-polled. The mashup module 600 may use other useful cache controls such as max-age, which specifies the maximum amount of time that a representation of a Web page will be considered fresh.

In one embodiment, the mashup module 600 may store a representation of the Web page associated with a data source, associated links, and embedded pages locally in one or more storage medium. For example, the mashup module 600 stores a representation of the ESPN® Web page and the pages associated with any links found on the Web page. In another embodiment, the mashup module 600 may only store a representation of the first Web page associated with the data source and may record any links associated with the first Web page. As a result, in these embodiments, the amount of content stored for any one data source is minimal. Thus, in various embodiments, there are several combinations of content that the mashup module 600 can be configured to obtain from each data source.

Return to FIG. 6A, at Step 603, the mashup module 600 receives a request for content from the subscriber. As will be described in further detail below, this request may be for the subscriber's mashup. Thus, in various embodiments, the mashup module 600 obtains the subscriber's configuration from storage, shown as Step 604. In other embodiments, the request may indicate the various sources are associated with the subscriber's mashup. Thus, the mashup module 600 reads the various data sources from the configuration or the request and retrieves from the stored content the content for the particular data sources. The mashup module 600 then generates one or more data packets from the first portion of content for each content item on the subscriber's mashup, shown as Step 605. As previously discussed, the mashup module 600 in various embodiments generates the data packets in an encoding format compatible with the provider's system 200. For instance, in one embodiment, the mashup module 600 calls a transcoder system 209 to transcode the portions of content for the content items into a format compatible with the provider's VOD system 204, such as CableLabs® MPEG2 Transport SD, CableLabs® MPEG2 Transport HD, H.264 Transport SD with MPEG audio or AAC audio, H.264 Transport HD with AAC audio, and/or H.264 web format with AAC audio.

In Step 606, the mashup module 600 transmits the generated data packets to the subscriber's set-top box 201a, 201b. Therefore, in the system 200 depicted in FIG. 2, the mashup module 600 transmits the data packets through the provider's headend 203, over the provider's cable distribution network 202, to the subscriber's set-top box 201a, 201b. In many instances, the data packets are transmitted over a unicast stream to the subscriber's set-top box 201a, 201b similar to VOD content. Thus, the headend 203 sends data to the set-top box 201a, 201b to instruct the set-top box 201a, 201b to tune to a channel carrying a stream comprising the data packets and transmits the data packets in the stream to the subscriber's set-top box 201a, 201b. In other embodiments, the headend 203 combines the data packets with the programming to be streamed to the subscriber's set-top box 201a, 201b into a combined stream. As a result, the headend 203 transmits the data packets and the programming to the subscriber's set-top box 201a, 201b over the combined stream.

In various embodiments, the data packets may be provided like any other type of content that is streamed to the set-top box 201a, 210b and the set-top box 201a, 210b simply generates signals to display the packets as received. For instance, in one embodiment, the mashup module 600 may utilize a system to construct one or more MPEGs, such as I-frames, to represent the mashup and may stream the MPEGs to the subscriber's set-top box 201a, 201b. Such a system is detailed in U.S. patent application Ser. No. 12/406,493 filed on Mar. 18, 2009 and entitled “Systems and Methods for Providing a Dynamic User Interface for a Settop Box,” which is incorporated herein by reference in its entirety.

In other embodiments, the mashup module 600 simply includes the content for the content items in the data packets that are provided to the set-top box 201a, 201b. Thus, in these particular embodiments, the set-top box 201a, 201b receives the packets and constructs the subscriber's mashup based on the subscriber's configuration stored on the set-top box 201a, 201b. As is described in more detail below, the set-top box 201a, 201b may include a stand-alone application that is configured to perform this task or another application (such as the VOD application) residing on the box 201a, 201b may be modified to perform this task. For instance, in one embodiment, a VOD application residing on the set-top box 201a, 201b that provides VOD service may be modified to receive the data packets and to construct the packets into the mashup based on the configuration. Once the set-top box 201a, 201b has constructed the mashup, the box 201a, 201b generates a signal based on the mashup so that the mashup may be displayed to the subscriber.

In other embodiments, the mashup module 600 is configured to obtain the content from the data source after receiving the request from the subscriber for the mashup. The flow diagram for these particular embodiments is shown in FIG. 6B. In these embodiments, the mashup module 600 receives the request for the content from the subscriber, shown as Step 612. In response, the mashup module 600 obtains the subscriber's configuration (if needed) and determines from the configuration or request what data sources are used on the subscriber's mashup. In a similar fashion as described above, the mashup module 600 then obtains the content from each data source specified in the subscriber's configuration, shown as Step 614. Further, in Step 615, the mashup module 600 generates data packets for the content in a similar fashion as described above. Finally, in Step 616, the module 600 transmits the data packets to the subscriber's set-top box 201a, 201b. Thus, in this particular embodiment, the mashup module 600 does not obtain the content for the subscriber's mashup until the module 600 has received the request from the subscriber. An advantage in various embodiments that use this approach is that the content that is displayed on the subscriber's mashup is always up to date. Therefore, in these particular embodiments, there is no need many times to rely on mechanisms to determine whether a data source needs to be re-polled.

Furthermore, it should be appreciated that the mashup module 600 in various embodiments is configured to do both. That is, in various embodiments, the mashup module 600 is configured to both obtain content from various data sources prior to receiving the request from the subscriber and obtain content from other data sources after receiving the request from the subscriber. For instance, in various embodiments, the mashup module 600 may be configured to poll certain data sources and store representations of these data sources locally because these sources are popular among subscribers' mashups. That is, these particular data sources are selected by a large number of the subscribers as content for their mashups. Therefore, in various embodiments, associated content for these data sources can be retrieved more quickly than having to poll the actual data source each time a mashup is requested that is configured with content from one of these data sources. In addition, the mashup module 600 may be configured to obtain the content from the less popular data sources after receiving a request for a mashup that includes content from one of these data sources. Therefore, in various embodiments, the storage requires may be reduced because the content for less popular data sources is not stored locally.

### Set-Top Box Module

In various embodiments, the subscriber's set-top box 201a, 201b may include some type of module 700 that is adapted to receive the data for the subscriber's mashup and provide a signal based on the data that is used to display the mashup (and corresponding content) on the subscriber's television screen. In particular embodiments, this module 700 may be a module that already exists on the subscriber's set-top box 201a, and 201b and has been modified to include mashup capabilities. For example, in various embodiments, the VOD module that resides on the set-top box 201a, 201b and provides VOD service for the subscriber may be modified to also provide mashup capabilities. In other particular embodiments, this module 700 is a stand-along module that resides on the set-top box 201a, 201b.

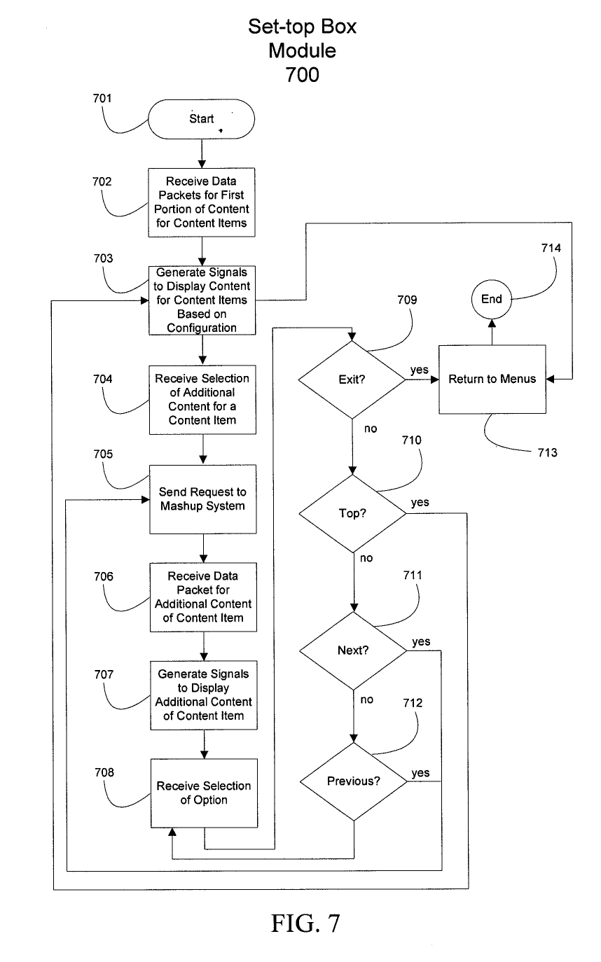

Accordingly, FIG. 7 illustrates a flow diagram of the set-top box module 700 according to various embodiments. This flow diagram may correspond to the steps carried out by the processor 404 in the set-top box 201a, 201b shown in FIG. 4 as it executes the module 700 in the set-top box's RAM memory 417 according to various embodiments.

Starting with Step 702, the set-top box module 700 receives the one or more data packets that include a first portion of content for each content item from the mashup system 206. As previously described, in various embodiments, the data packets may simply include the first portion of content for each content item. In these particular embodiments, the set-top box module 700 constructs the subscriber's mashup based on a locally stored configuration. The set-top box module 700 reads the subscriber's configuration, assembles the subscriber's mashup based on the configuration, and generates signals to display the mashup on the subscriber's television, shown as Step 703. In other embodiments, the mashup system 206 may provide the data packets to the set-top box module 700 with the mashup already constructed and the module 700 simply generates the signals to display the packets as received.

As a result, the subscriber's mashup is displayed on the subscriber's television screen. The mashup includes the portions of content for the content items identified in the subscriber's configuration and the portions are formatted as indicated in the subscriber's configuration. The subscriber can then read and view the various portions of content for the content items on the screen. Further, the subscriber may wish to view additional content associated with a particular content item shown on the mashup. For example, the subscriber's mashup may include the current headlines from the CNN® website and the subscriber may desire to read the news article associated with one of the headlines. In various embodiments, the subscriber indicates to view additional content for the item through some mechanism, such as the subscriber's remote control, a keyboard in communication with the set-top box 201a, 201b, and/or an on-screen keyboard, and sends a request to the set-top box module 700 for the additional content.

In Step 704, the set-top box module 700 receives the selection of additional content for the particular content item. In Step 705, the set-top box module 700 sends the request to the mashup system 206. In various embodiments, the request may include such information as the unique identifier of the subscriber. This identifier may have been provided along with the original data packets that were received to provide the mashup or may have been stored locally on the set-top box 201a, 201b. The request may also include an identifier that identifies the particular content item.

Thus, the request is routed over the provider's cable distribution network 202, through the provider's headend 203, and to the mashup system 206. In various embodiments, the mashup module 700 residing on the mashup system 206 receives the request and processes the request by accessing the data source associated with the content item to obtain the additional content. In particular embodiments, the additional content may be an amount of content that will fit on the subscriber's television screen. For instance, in one embodiment, the mashup module 700 provides an amount of content that fits on a reader pane template that is configured according to a television screen. For instance, in various embodiments, the subscriber indicates the size of his or her television screen at the time of configuring his or her mashup so that an appropriate reader pane template is identified. While in other embodiments, the request received for the page of content may include an identifier of the television screen size. While in other embodiments, the subscriber's set-top box 201a, 201b may store the appropriate reader pane template and the set-top box module 700 may configure the content according to the template. The mashup module 700 converts the additional content into one or more data packets and transmits the data packets to the subscriber's set-top box 201a, 201b.

In Step 706, the set-top box module 700 receives the data packets and generates a signal from the data packets to display the additional content for the content item to the subscriber, shown as Step 707. Thus, in the example, the subscriber is provided with the first page of the news article associated with the headline selected by the subscriber. The subscriber reads the page of the article and decides what action he or she would like to take next with regard to the news article. For instance, the subscriber may wish to read the next page of the article or may wish to exit the page and return to the subscriber's mashup.

Therefore, in Step 708, the set-top box module 700 receives a selection of an option from the subscriber. As previously described, the subscriber may enter his or her choice of option through various mechanisms, such as a remote control, a keyboard in communication with the set-top box 201a, 201b, and/or an on-screen keyboard. As a result of receiving the subscriber's selection of an option, the set-top box module 700 determines which option the subscriber has selected.

In the particular embodiment of the set-top box module 700 shown in FIG. 7, the module 700 first determines whether the subscriber has selected the “exit” option. In this particular embodiment, the “exit” option is configured to return the subscriber out of the subscriber mashup to the menus on the set-top box 201a, 201b the subscriber used to request the mashup. For example, the subscriber's set-top box 201a, 201b may be configured so that the subscriber requests his or her mashup through the VOD service provided on the set-top box 201a, 201b. Thus, in this case, the subscriber is returned to the VOD menus upon exiting his or her mashup. Therefore, if the set-top box module 700 determines the subscriber has selected the “exit” option, the module 700 returns the subscriber to the set-top box menus, shown as Step 713.

If the set-top box module 700 determines the subscriber has not selected the “exit” option, the set-top box next determines whether the subscriber has selected the “top” option, shown as Step 710. In this particular embodiment, the “top” option is configured to return the subscriber to his or her mashup. Thus, if the set-top box module 700 determines the subscriber has selected the “top” option, the module 700 returns to Step 703 and generates signals for the subscriber's mashup from the data packets received after the subscriber had made the original request for his or her mashup. In one particular embodiment, these data packets are cached in memory in the set-top box 201a, 201b so that they may be retrieved without having to send another request to the mashup system 206. In another embodiment, the set-top box module 700 re-requests the data packets from the mashup system 206. In turn, the subscriber is provided with the mashup on his or her television screen. At this point, in various embodiments, the subscriber may select another content item to request additional content for or the subscriber may exit the mashup and return to the set-top box menus.

Returning to FIG. 7, if the set-top box module 700 determines that the subscriber has not selected the “top” option, the module 700 determines whether the subscriber has selected the “next” option. In this particular embodiment, the “next” option is configured to request additional content (e.g., “next page of content”) for the particular content item. If the set-top box module 700 determines the subscriber has selected this option, the set-top box module 700 returns to Step 705 and sends a request to the mashup system 206 for the additional content (e.g., next page of content). Thus, the mashup system 206 receives the request and sends the set-top box module 700 the data packets for the additional content. In response, the set-top box module 700 receives the data packets, and generates signals to display the additional content to the subscriber.

Furthermore, if the set-top box module 700 determines that the subscriber has not selected the “next” option, the module 700 determines whether the subscriber has selected the “previous” option, shown as Step 712. In this particular embodiment, the “previous” option is configured to request previously retrieved content (e.g., “previous page of content”) for the particular content item. If the set-top box module 700 determines the subscriber has selected this option, the module 700 also returns to Step 705 and sends a request to the mashup system 206 for the previous content. As a result, the set-top box module 700 receives one or more data packets from the mashup system 206 and generates signals from the data packets to display the previous content to the subscriber.

If the set-top box module 700 determines that the subscriber has not selected the “next” option, the module 700 returns to Step 708 to receive a valid selection of an option from the subscriber. In various embodiments, the module 700 may also display a message to the subscriber informing him or her that the entered option was not valid.

Thus, the set-top box module 700 allows the subscriber to view the subscriber's mashup and to request additional content related to content items found on the subscriber's mashup. In addition, it should be appreciated by one of ordinary skill in the art that the options the subscriber may select from may be evaluated by the set-top box module 700 in other orders besides the order depicted in FIG. 7 according to various embodiments. The order shown in FIG. 7 is provided for illustrative purposes only and should not be construed to limit the scope of the claimed invention.

Further, in various embodiments, the set-top box module 700 may be configured to notify the subscriber of updated content on the subscriber's mashup. Thus, the set-top box module 700 may receive data packets from the mashup module 600 that indicates one or more of the content items on the subscriber's mashup have updated content.

For instance, a subscriber may have configured his or her mashup to include one or more of the subscriber's friends from facebook®. The mashup module 600 may be configured to periodically poll the subscriber's facebook® page and may detect that the status for one or more of the subscriber's friends has changed. In response, the mashup module 600 transmits one or more data packets to the subscriber's set-top box 201a, 201b that contain the status updates. The set-top box module 700 detects the status updates from the data packets and generates signals to display on the subscriber's television screen notifying the subscriber of the updates. For example, an update alert may be provided on a VOD application screen notifying the subscriber of the status change for the subscriber's facebook® friends. In another example, the ticker that was previously described may have a message that runs across the subscriber's television notifying the subscriber of the status change for the subscriber's facebook® friends.

### Exemplary Example of a Subscriber's Mashup

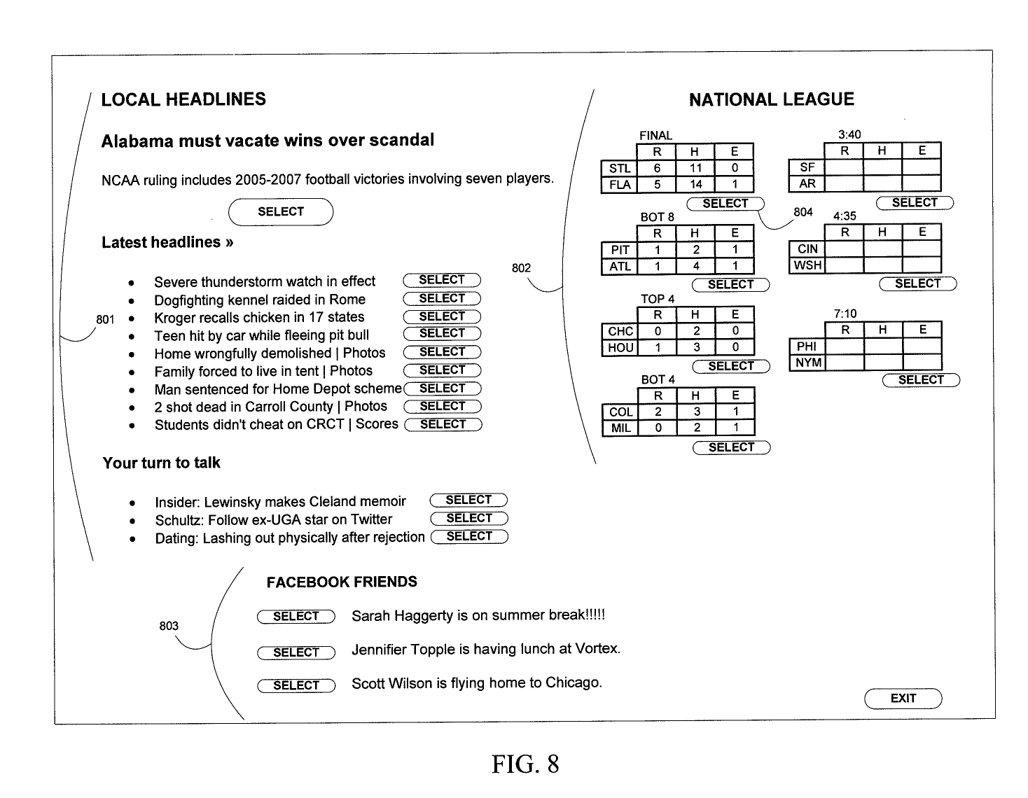

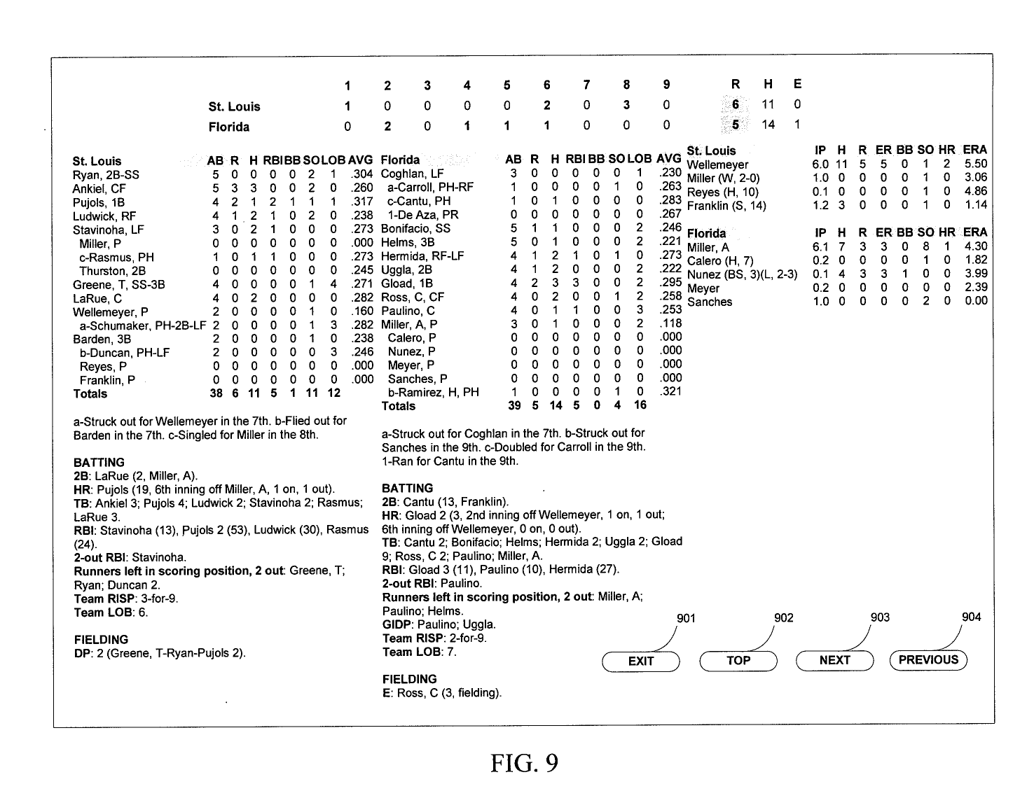

FIGS. 8 and 9 provide an example of a subscriber's mashup according to various embodiments. As previously described, a subscriber first configures his or her mashup and indicates what content items to include on the mashup. In this particular example, the subscriber selects a template that includes three partitioned areas as the screen layout. The, subscriber selects the first content item to be the local news headlines in Atlanta. Thus, in various embodiments, the subscriber selects this content item and indicates the data source for the item. For example, the configuration tool may provide a listing of data sources for local news headlines and the subscriber may select a particular data source from the listing, such as the website for Atlanta Journal Constitution®. Further, the subscriber selects a content format for the first content item. For instance, the subscriber selects the upper left partition of the template for displaying the Atlanta local news headlines.

The subscriber continues to configure his or her mashup and selects major league baseball scores from the national league. Similar to the first content item, the subscriber selects (or enters) a data source for the second content item, such as official website for Major League Baseball®, and selects the content format for the item, e.g., the upper right partition of the template. Finally, the subscriber selects his or her final content item to include on the mashup. In this example, the subscriber selects three friends from facebook® to display in the lower partition of the mashup.

As previously discussed, the subscriber's configuration is saved and this configuration is used to construct the subscriber's mashup upon request. Thus, the subscriber selects the mashup option listed in the VOD service provided by the subscriber's cable provider and a request is sent for the mashup. The content for the content items are retrieved, and depending on the embodiment, the mashup is constructed on cable provider's system 200, such as the mashup system 206, or on the subscriber's set-top box 201a, 201b. In turn, the set-top box 201a, 201b generates signals and displays the mashup on the subscriber's television screen.

As can be seen in FIG. 8, the mashup displays the local headlines 801 in the upper left corner (e.g., partition) of the mashup, the national league baseball scores 802 in the upper right corner of the mashup, and the subscriber's facebook® friends 803 in the bottom half of the mashup. In addition, the mashup provides “SELECT” buttons for particular content for each content item. Thus, the subscriber can use his or her remote control to tab through the “SELECT” buttons to desired content if he or she would like to see additional content.

For instance, the subscriber may be interested in seeing the box score for the St. Louis/Florida baseball game. Therefore, the subscriber tabs through the “SELECT” buttons until the “SELECT” button 804 for the game is highlighted and the subscriber selects the “ENTER” button on his or her remote control.

A request is sent to the mashup system 206 to provide the additional content for the box score. The mashup system 206 retrieves the content for the box score and streams the content to the subscriber's set-top box 201a, 201b. The set-top box 201a, 201b generates signals from the streamed content and displays the box score on the subscriber's television screen. As previously discussed, in various embodiments, the set-top box 201a, 201b may receive the content already formatted and the set-top box 201a, 201b simply generates the signals to display the box score. In other embodiments, the set-top box 201a, 201b may first construct the box score page to display on the television screen from a reader pane template that is stored locally on the set-top box 201a, 201b.

Thus, the box score is displayed on the subscriber's television screen as shown in FIG. 9. The subscriber may read the information on the box score and may select one of four choices provided on the screen. First, the subscriber may exit the mashup by selecting the “EXIT” button 901. Second, the subscriber may return to the mashup by selecting the “TOP” button 902. Third, the subscriber may request the next page of information for the box score by selecting the “NEXT” button 903. Fourth, the subscriber may request the previous page of information for the box score by selecting the “PREVIOUS” button 904. (Note that in various embodiments all four buttons may not be provided on each page depending on whether there is a next page and/or previous page of content for the particular content.) Therefore, the subscriber can select any one of these four choices by tabbing through the four buttons via the subscriber's remote control. If the subscriber returns to his or her mashup, the subscriber may then select content for another content item on the mashup to view further content.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing a mashup comprising at least two content items in at least one display format to a subscriber of a cable service provider comprising:
a computer system adapted to:
(a) host a configuration tool;
(b) receive from the subscriber accessing the configuration tool a configuration for the mashup comprising:
(1) a unique identifier identifying the subscriber;
(2) at least one data source associated with the at least two content items; and
(3) at least one display format for the at least two content items;
(c) store the configuration in a memory;
(d) obtain content for the at least two content items by accessing the at least one data source over a network;
(e) receive a request for the mashup over a cable service provider's cable network from a subscriber's set-top box; and
(f) in response to receiving the request,
(1) obtain the subscriber's configuration from the memory by using the unique identifier; and
(2) generate one or more data packets in a MPEG format, the one or more data packets representing at least a portion of the content for the at least two content items in the at least one display format based on the subscriber's configuration indicating the at least one data source and the at least one display format; and
a headend adapted to:
(a) transmit data identifying a stream comprising the one or more data packets over the subscriber's cable network to the subscriber's set-top box; and
(b) transmit the one or more data packets over the stream to the subscriber's set-top box, wherein the subscriber's set-top box tunes to the stream based on the data and generates signals from the one or more data packets to display the mashup that comprises the portion of the content of the at least two content items in the at least one display format.

2. The system of claim 1, wherein the stream is a unicast stream.

3. The system of claim 1, wherein the one or more data packets comprise one or more I-frames.

4. The system of claim 1, wherein the computer system obtains the content for the at least two content items in response to receiving the request.

5. The system of claim 1, wherein the computer system obtains the content for the at least two content items automatically after a predetermined time period or after an indicator indicates the content needs to be refreshed.

6. The system of claim 1, wherein:
the computer system is further adapted to:
receive a subsequent request from the subscriber's set-top box for further content for one content item of the at least two content items;
obtain the further content for the one content item;
generate one or more data packets from the further content in an MPEG format; and
the headend is further adapted to:
transmit the one or more data packets over the stream to the subscriber's set-top box, wherein the subscriber's set-top box generates signals from the one or more data packets to display the further content for the one content item.

7. The system of claim 1, wherein:
the computer system is further adapted to:
receive from the subscriber the configuration further comprising:
a selection of a first data source associated with a first content item;
a selection of a first display format comprising a first screen area on the mashup for the first content item;
a selection of a second data source associated with a second content item; and
a selection of a second display format comprising a second screen area on the mashup for the second content item; and
in response to receiving the request for the mashup over the cable service provider's cable network from the subscriber's set-top box,
generate one or more data packets in an MPEG format, the one or more data packets representing at least a portion of the content for the first content item in the first display format and at least a portion of the second content item in the second display format based on the subscriber's configuration indicating the first data source, the first display format, the second data source, and the second display format; and
the headend is further adapted to:
transmit the one or more data packets over the stream to the subscriber's set-top box, wherein the subscriber's set-top box generates signals from the one or more data packets to display the mashup comprising the content of the first content item in the first screen area and the content of the second content item in the second screen area.

8. A method for providing a mashup comprising at least two content items in at least one display format to a subscriber of a cable service provider, the method comprising the steps of:
(a) hosting a configuration tool on at least one computer device;
(b) receiving from the subscriber accessing the configuration tool a configuration for the mashup comprising:
(1) a unique identifier identifying the subscriber;
(2) at least one data source associated with the at least two content items; and
(3) at least one display format for the at least two content items;
(c) storing the configuration in a memory;
(d) obtaining content for the at least two content items by having the at least one computer device access the at least one data source over a network;
(e) receiving a request for the mashup over a cable service provider's cable network from a subscriber's set-top box;
(f) in response to receiving the request,
(1) obtaining the subscriber's configuration from the memory by having the at least one computer device use the unique identifier;
(2) having the at least one computer device generate one or more data packets in an MPEG format, the one or more data packets representing at least a portion of the content of the at least two content items in the at least one display format based on the subscriber's configuration indicating the at least one data source and the at least one display format;
(3) transmitting data identifying a stream comprising the one or more data packets over the cable service provider's network to the subscriber's set-top box; and
(4) transmitting the one or more data packets over the stream to the subscriber's set-top box, wherein the subscriber's set-top box tunes to the stream based on the data and generates signals from the one or more data packets to display the mashup comprising the portion of content for the at least two content items in the at least one display format.

9. The method of claim 8, wherein the stream is a unicast stream.

10. The method of claim 8, wherein the one or more data packets comprise one or more I-frames.

11. The method of claim 8, wherein the step of obtaining the content for the at least two content items is carried out in response to receiving the request.

12. The method of claim 8, wherein the step of obtaining the content for the at least two content items is carried out automatically after a predetermined time period or after an indicator indicates the content needs to be refreshed.

13. The method of claim 8 further comprising the steps of:
receiving a subsequent request from the subscriber's set-top box for further content for one content item of the at least two content items over the cable service provider's cable network from the subscriber's set-top box;
obtaining the further content for the one content item;
having the at least one computer device generate one or more data packets from at least a portion of the further content in an MPEG format; and
transmitting the one or more data packets over the stream to the subscriber's set-top box, wherein the subscriber's set-top box generates signals from the one or more data packets to display the further content for the one content item.

14. The method of claim 8 further comprising the steps of:
receiving from the subscriber the configuration further comprising:
a selection of a first data source associated with a first content item;
a selection of a first display format comprising a first screen area on the mashup for the first content item;
a selection of a second data source associated with a second content item; and
a selection of a second display format comprising a second screen area on the mashup for the second content item; and
in response to receiving the request for the mashup over the cable service provider's cable network from the subscriber's set-top box,
having the at least one computer device generate one or more data packets in an MPEG format, the one or more data packets representing at least a portion of the content of the first content item in the first display format and at least a portion of the content of the second content item in the second display format based on the subscriber's configuration indicating the first data source, the first display format, the second data source, and the second display format; and
transmitting the one or more data packets over the stream to the subscriber's set-top box, wherein the subscriber's set-top box generates signals from the one or more data packets to display the mashup comprising the first content item in the first screen area and the second content item in the second screen area.

15. A system for providing a mashup comprising at least two content items in at least one display format to a subscriber of a cable service provider comprising:
a computer system adapted to:
(a) host a configuration tool;
(b) receive from the subscriber accessing the configuration tool a configuration for the mashup comprising:
(1) a unique identifier identifying the subscriber;
(2) at least one data source associated with the at least two content items; and
(3) at least one display format for the at least two content items;
(c) store the configuration in a memory;
(d) obtain content for the at least two content items by accessing the at least one data source over a network;
(e) receive a request for the mashup over a cable service provider's cable network from a subscriber's set-top box; and
(f) in response to receiving the request,
(1) obtain the subscriber's configuration from the memory by using the unique identifier; and
(2) generate one or more data packets in an MPEG format, the one or more data packets representing at least a portion of the content for the at least two content items in the at least one display format based on the subscriber's configuration indicating the at least one data source and the at least one display format; and
a headend adapted to:
(a) combine the one or more data packets with current content to be streamed over the cable service provider's network to the subscriber's set-top box in a combined stream; and
(b) transmit the combined stream over the cable service provider's network to the subscriber's set-top box, wherein the subscriber's set-top box generates signals from the combined stream to display the mashup that comprises the portion of the content of the at least two content items in the at least one display format.

16. The system of claim 15, wherein the mashup visually appears to be superimposed over the current content.

17. The system of claim 15, wherein the headend is further adapted to, in response to the subscriber changing the current content to be streamed to the subscriber's set-top box to new content to be streamed to the subscriber's set-top box:
combine the one or more data packets with the new content in a new combined stream; and
transmit the new combined stream over the cable service provider's network to the subscriber's set-top box, wherein the subscriber's set-top box generates signals from the new combined stream to display the mashup.

18. The system of claim 15, wherein the
the computer system is further adapted to:
receive a subsequent request from the subscriber's set-top box for further content for one content item of the at least two content items;
obtain the further content for the one content item;
generate one or more data packets from the further content in an MPEG format; and
the headend is further adapted to:
transmit data identifying a stream comprising the one or more data packets from the further content over the subscriber's cable network to the subscriber's set-top box; and
transmit the one or more data packets from the further content over the stream to the subscriber's set-top box, wherein the subscriber's set-top box tunes to the stream based on the data and generates signals from the one or more data packets from the further content to display the further content.

19. The system of claim 18, wherein the subscriber's set-top box is configured to record the current content while the further content is being displayed.

20. The system of claim 15, wherein the
the computer system is further adapted to:
receive a subsequent request from the subscriber's set-top box for further content for the at least two content items;
obtain the further content for the at least two content items;
generate one or more data packets from the further content in an MPEG format; and
the headend is further adapted to:
transmit data identifying a stream comprising the one or more data packets from the further content over the subscriber's cable network to the subscriber's set-top box; and
transmit the one or more data packets from the further content over the stream to the subscriber's set-top box, wherein the subscriber's set-top box tunes to the stream based on the data and generates signals from the one or more data packets from the further content to display the further content.

21. The system of claim 20, wherein the subscriber's set-top box is configured to record the current content while the further content is being displayed.

22. A method for providing a mashup comprising at least two content items in at least one display format to a subscriber of a cable service provider, the method comprising the steps of:
(a) hosting a configuration tool on at least one computer device;
(b) receiving from the subscriber accessing the configuration tool a configuration for the mashup comprising:
(1) a unique identifier identifying the subscriber;
(2) at least one data source associated with the at least two content items; and
(3) at least one display format for the at least two content items;
(c) storing the configuration in a memory;
(d) obtaining content for the at least two content items by having the at least one computer device access the at least one data source over a network;
(e) receiving a request for the mashup over a cable service provider's cable network from a subscriber's set-top box;
(f) in response to receiving the request,
(1) obtaining the subscriber's configuration from the memory by having the at least one computer device use the unique identifier;
(2) having the at least one computer device generate one or more data packets in an MPEG format, the one or more data packets representing at least a portion of the content of the at least two content items in the at least one display format based on the subscriber's configuration indicating the at least one data source and the at least one display format;
(3) combining the one or more data packets with current content to be streamed over the cable service provider's network to the subscriber's set-top box in a combined stream; and
(4) transmitting the combined stream over the cable service provider's network to the subscriber's set-top box, wherein the subscriber's set-top box generates signals from the combined stream to display the mashup that comprises the portion of the content of the at least two content items in the at least one display format.

23. The method of claim 22, wherein the mashup visually appears to be superimposed over the current content.

24. The method of claim 22 further comprising the steps of, in response to the subscriber changing the current content to be streamed to the subscriber's set-top box to new content to be streamed to the subscriber's set-top box:
combining the one or more data packets with the new content in a new combined stream; and
transmitting the new combined stream over the cable service provider's network to the subscriber's set-top box, wherein the subscriber's set-top box generates signals from the new combined stream to display the mashup.

25. The method of claim 22 further comprising the steps of:
receiving a subsequent request from the subscriber's set-top box for further content for one content item of the at least two content items;
obtaining the further content for the one content item;
having the at least one computer device generate one or more data packets from the further content in an MPEG format;
transmitting data identifying a stream comprising the one or more data packets from the further content over the subscriber's cable network to the subscriber's set-top box; and
transmitting the one or more data packets from the further content over the stream to the subscriber's set-top box, wherein the subscriber's set-top box tunes to the stream based on the data and generates signals from the one or more data packets from the further content to display the further content.

26. The method of claim 25 further comprising the step of recording the current content while the further content is being displayed.

27. The method of claim 22 further comprising the steps of:
receiving a subsequent request from the subscriber's set-top box for further content for the at least two content items;
obtaining the further content for the at least two content items;
having the at least one computer device generate one or more data packets from the further content in an MPEG format;
transmitting data identifying a stream comprising the one or more data packets from the further content over the subscriber's cable network to the subscriber's set-top box; and
transmitting the one or more data packets from the further content over the stream to the subscriber's set-top box, wherein the subscriber's set-top box tunes to the stream based on the data and generates signals from the one or more data packets from the further content to display the further content.

28. The method of claim 27 further comprising the step of recording the current content while the further content is being displayed.

29. A computer-readable medium containing code executable by a processor for providing a mashup comprising at least two content items in at least one display format to a subscriber of a cable service provider comprising computer-readable program instructions adapted for:
(a) hosting a configuration tool;
(b) receiving from the subscriber accessing the configuration tool a configuration for the mashup comprising:
(1) a unique identifier identifying the subscriber;
(2) at least one data source associated with the at least two content items; and
(3) at least one display format for the at least two content items;
(c) storing the configuration in a memory;
(d) obtaining content for the at least two content items by accessing the at least one data source over a network;
(e) receiving a request for the mashup over a cable service provider's cable network from a subscriber's set-top box;
(f) in response to receiving the request,
(3) transmitting data identifying a stream comprising the one or more data packets over the cable service provider's network to the subscriber's set-top box; and
(4) transmitting the one or more data packets over the stream to the subscriber's set-top box, wherein the subscriber's set-top box tunes to the stream based on the data and generates signals from the one or more data packets to display the mashup comprising the portion of content for the at least two content items in the at least one display format.

30. A computer-readable medium containing code executable by a processor for providing a mashup comprising at least two content items in at least one display format to a subscriber of a cable service provider comprising computer-readable program instructions adapted for:
(a) hosting a configuration tool;
(b) receiving from the subscriber accessing the configuration tool a configuration for the mashup comprising:
(1) a unique identifier identifying the subscriber;
(2) at least one data source associated with the at least two content items; and
(3) at least one display format for the at least two content items;
(c) storing the configuration in a memory;
(d) obtaining content for the at least two content items by accessing the at least one data source over a network;
(e) receiving a request for the mashup over a cable service provider's cable network from a subscriber's set-top box;
(f) in response to receiving the request,
(1) obtaining the subscriber's configuration from the memory by using the unique identifier;
(2) generating one or more data packets in an MPEG format, the one or more data packets representing at least a portion of the content of the at least two content items in the at least one display format based on the subscriber's configuration indicating the at least one data source and the at least one display format;
(3) combining the one or more data packets with current content to be streamed over the cable service provider's network to the subscriber's set-top box in a combined stream; and
(4) streaming the combined stream over the cable service provider's network to the subscriber's set-top box, wherein the subscriber's set-top box generates signals from the combined stream to display the mashup that comprises the portion of the content of the at least two content items in the at least one display format.
